(19) United States
(12) Patent Application Publication
(10) Pub. No.: US 2013/0126604 A1
(43) Pub. Date: May 23, 2013

(54) ALL-CARD-IN-ONE SYSTEM

(71) Applicants: Richard Tabor, Elizabeth, NJ (US); Jadniel N. Pimentel, Elizabeth, NJ (US)

(72) Inventors: Richard Tabor, Elizabeth, NJ (US); Jadniel N. Pimentel, Elizabeth, NJ (US)

(21) Appl. No.: 13/682,013

(22) Filed: Nov. 20, 2012

Related U.S. Application Data
(60) Provisional application No. 61/563,066, filed on Nov. 23, 2011.

(51) Int. Cl. G06Q 10/00

(52) U.S. Cl. CPC G06Q 10/00
USPC 235/379

(57) ABSTRACT

The all-card-in-one (ACIO) system described herein allows a user to use a single ACIO card to work as a replacement all his/her credit cards, debit cards, promotional cards, discount cards, and all other cards suitable for financial transactions. In the same manner, the chances to have a card lost or stolen are reduced, bolstering the security of the user's financial information. The ACIO card may be used to access regular card readers as well as ACIO terminals. The ACIO terminals list the entire collection of a user's cards and allow the user to access any one or a combination of the cards to finish a financial transaction. Moreover, when the user is fully verified with the ACIO system, he/she may be able to access the ACIO system through biometric recognition technologies such as fingerprint scanner or facial recognition. Such a “no card” access significant improves both convenience and security.

### CLAIM OF PRIORITY

This application claims the priority of U.S. Ser. No. 61/563,066 filed on Nov. 23, 2011, the contents of which are fully incorporated herein by reference.

### FIELD OF THE INVENTION

The invention relates to an all-card-in-one (ACIO) system. The ACIO system is a convenient and secure way to complete a financial transaction. In particular, the ACIO system stores the information and serves as a replacement for a user's entire collection of credit cards, debit cards, promotional cards, and discount cards.

1. Background of the Invention

Nowadays, an average consumer usually has many cards stuffed in his/her wallet. Aside from the personal identification cards such as a driver's license, most people carry multiple credit cards, debit cards, promotional cards, and discount cards for functions such as purchases, cash retrieval and money transfer. Take credit cards for example, according to the statistics of creditcards.com, an average consumer in the U.S. possesses 3.5 credit cards.

It is bewildering to carry around many cards. When a consumer has multiple credit cards, debit cards, promotional cards, and discount cards, it is more likely that he/she would be confused as to which card serves what purpose. It is also more difficult to manage one's finances when multiple cards are carried around and used. A user probably would not be able to track the use of a particular card for each transaction. For example, when a rarely-used card is employed to pay for a small purchase, the consumer may forget that the card was ever used, subjecting the consumer to possible transactional charges such as late fees.

Moreover, it is insecure to carry around many cards. When the user takes one card out of the wallet, another card may be inadvertently dragged out and lost, subjecting the user to fraudulent financial transactions. An even greater risk emerges when a consumer loses his/her wallet and the entire collection of cards. Since the cards do not have further security measures implemented, the user may suffer fraudulent charges as well as identity theft.

The current invention provides solutions to the above indicated problems. The All-card-in-one (ACIO) system introduced here permits the user to secure the relevant information regarding all of his/her credit card, debit cards, promotion cards, and discount cards in a single account. The ACIO system reduces confusion by allowing the user to put away the physical copies of most of his/her cards. The user no longer needs to carry all the cards. He/she may use the ACIO card to work as a replacement for most, if not all, of his/her card collections. In the same manner, the chances to have a card lost or stolen are reduced, bolstering the security of the user's financial information. Moreover, when the user is fully verified with the ACIO system, he/she may be able to access the ACIO system through biometric recognition technologies such as fingerprint scanner or facial recognition. Such a “no card” access significant improves the security of the user's financial information.

2. Description of the Related Art

U.S. Pat. No. 6,308,890 discloses an apparatus and a method providing for creating multiple spatial patterns, such as magnetic patterns on credit cards. The invention includes storage of information from which patterns may be created, a pattern creation device for creating the spatial patterns, and control whereby the information which is stored is selectively utilized to cause the pattern creation. This allows multiple desired patterns to be simulated, allowing convenient replacement of a number of separate pattern carrying devices.

U.S. Publication 2010/0212253 discloses an All in one card, an arrangement and methods for contact- and contactless-services, e.g. payments, money transfer, electronic tickets or identity cards. The All in one card comprises a point of service interface for communication with a point of service, a card database, a mobile terminal interface for connect the card to a mobile terminal connectable to a telecommunication network. The card database can be controlled by the mobile terminal. The card database is configured for storing data and the card data can be accessed via the point of service interface. The date stored in the card database relates to e.g. bank cards, credit cards, identification, tickets, electronic money, identification 15 cards. The invention also comprises a mobile terminal (MT) suitable for communication with the card.

Various implements are known in the art, but their structures are distinctively different from the current invention. Moreover, the prior arts fail to address all of the problems solved by the invention described herein. One embodiment of this invention is illustrated in the accompanying drawings and will be described in more detail herein below.

### SUMMARY OF THE INVENTION

The current invention introduces the ACIO system, which allows the user to compile the information for all of his/her credit card, debit cards, promotion cards, and discount cards—the cards directly involved in financial transactions—in a single database, which can be accessed by the businesses that are authorized to handle financial transaction by credit cards, debit cards, promotional cards, and discount cards. Through a secure portal, the ACIO user can register for an ACIO account and input all the necessary information for his/her cards and verification of his/her identity. The ACIO account serves as a “one-stop-shop” interface between the ACIO user and all his/her cards. The user can manager his/her cards and transactions with the ACIO account, reducing the likelihood of confusion and missing payments.

The ACIO system may also include a card (termed as “ACIO card”) that can be swiped at regular card-readers. The ACIO card may be programmable to allow the card to store more than one number. Through the ACIO system, the user may designate his/her ACIO card to store the information of several cards, such as a combination of a credit card, a debit card, a promotional card, and a discount card. Through initiating a triggering device on the ACIO card, the user may further designate the ACIO card to work as one particular card in a specific transaction.

The ACIO system may also include an ACIO terminal, which allows the user to access all his/her cards and choose any one or any combination of the cards to complete a transaction, such as a purchase or a cash withdrawal. The ACIO user can use an ACIO card to access the ACIO terminal. With the ACIO terminal, the user does not need to make designations on the ACIO card to point to which card will be used in a particular transaction. The user can simply choose on the ACIO terminal once his/her identify is verified by swiping the ACIO card and matching of his/her picture that show up on the ACIO terminal. Further still, after additional steps of verification that is completed online or by mail or in person, the ACIO user can access the ACIO terminal without any card. By equipping a biometric recognition system such a fringerprint scanner, a retina scanner, or a facial recognition program, the ACIO terminal can be accessed direct without any card. The ACIO user can then designate, on the ACIO terminal, which of his/her credit card, debit card, promotional card, or discount card, or any combinations thereof, will be used for a particular transaction.

By designating the card(s) used for a transaction at a point of sale or cash withdrawal, the ACIO user enables the merchant making the sale or providing the cash to dial into an ACIO processing server to verify the designation. Once verified, the information may be relayed to the issuing organization or bank for authorization and approval. When an approval is provided, the merchant then would be able to finish the transactions. Such a designation for a specific transaction can also be made at the ACIO terminal. The sequence of verification and approval is the same. The locations that have implemented the ACIO terminal enjoy the convenience that an ACIO user can access the ACIO terminal without any card. More customers may choose such locations in preference to other locations that are only equipped with regular card readers.

The ACIO system reduces confusion by allowing the user to put most of the physical copies his/her cards away. The user no longer needs to carry all the cards. He/she may use the ACIO card to work as most, if not all, of his/her card collections. Similarly, the ACIO system improves security for the user's financial information by reducing the chance that a user's card is lost or stolen. The user may use an online account to access the ACIO system. Through encryption technology and other security measures, the user may input the information regarding his/her cards into the ACIO system and make the necessary designations. Moreover, when the user is fully verified with the ACIO system, he/she may be able to access the ACIO system through biometric recognition technologies such as fingerprint scanner or facial recognition. Such a “no card” access not only provides more convenience but also significant improves the security of the user's financial information.

It is an object of the present invention to provide an ACIO system that allows a user to carry one card to complete all the transactions for all his/her credit cards, debit cards, promotional cards, and discount cards.

It is another object of the present invention to provide an ACIO system that ensures higher level of security for the user's financial information and prevents identity theft.

Still another object of the present invention is to provide an ACIO system that allows a user of the system to manage all the financial information regarding of his/her credit cards, debit cards, promotional cards, and discount cards on one account on one website.

Yet another object of the present invention is to provide an ACIO system that allows a user to access the information of his/her credit card, debit card, promotional card and discounts in an ACIO terminal by swiping a card and choose which card he/she will use for a particular transaction.

Still another object of the present invention is to provide an ACIO system that allows a user to access the information of his/her credit card, debit card, promotional card and discounts in an ACIO terminal by fingerprint or facial recognition technologies and choose which card he/she will use for a particular transaction.

Still another object of the present invention is to provide an ACIO system that generates an email or automated phone message, either textual or verbal, to alert the user when a financial transaction using the ACIO system is taking place.

### BRIEF DESCRIPTION OF THE DRAWINGS

FIG. 1 is a drawing demonstrating the preferred embodiment of the present invention and showing the interactions between a user, an ACIO card, an ACIO card terminal, a regular card reader, and an ACIO account.

FIG. 2A shows the front view of an ACIO card with a magnetic strip in diagram form.

FIG. 2B shows the back view of the ACIO card with a magnetic strip in diagram form.

FIG. 3 is a drawing demonstrating an ACIO terminal in diagram form.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

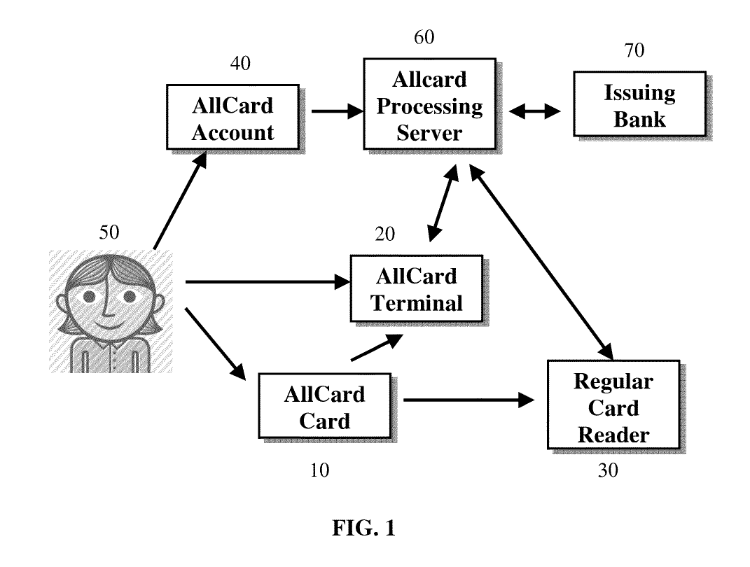

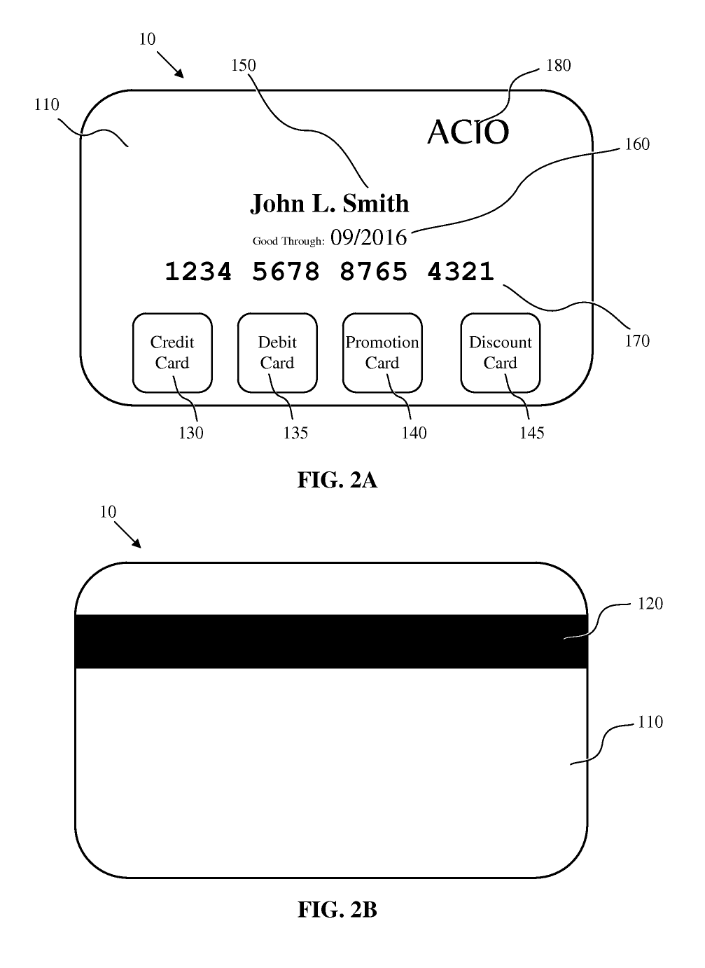

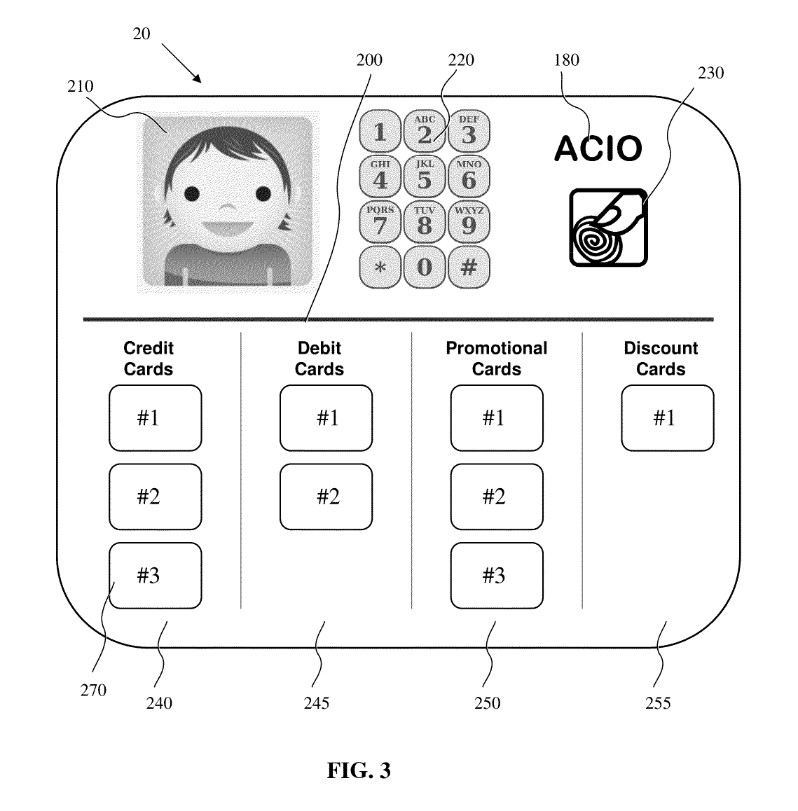

FIGS. 1, 2 and 3 provide a general illustration of the ACIO system. FIG. 1 is an overview of the interactions between the essential components of the ACIO system. FIGS. 2A and 2B illustrate the basic structure of an ACIO card. FIG. 3 shows a simplified ACIO terminal. The figures and the numerals may be cross-referenced.

FIG. 1 shows the interactions between a user 50, an ACIO card 10, an ACIO terminal 20, a regular card reader 30, an online ACIO Account 40, an ACIO processing sever 60, and an issuing bank 70 in diagram form. The arrows connecting the different components indicate the flow of information. The overall diagram states how a user's financial information for his/her cards is stored, transferred, and used in regard to particular transactions and how the ACIO card 10 and the ACIO terminal 20 may facilitate such transactions and improve security.

The ACIO account 40 serves as an interface between the user 50 and the ACIO system. The user 50 may set up an ACIO account 40 online at an ACIO website through a secured portal. After certain verification regarding the user's identity, the user 50 may store the information regarding his/her credit cards, debit cards, promotional cards, and discount cards in the ACIO account 40. Thereafter, the user 50 may use the ACIO account 40 to choose which credit card, debit card, promotional card, and discount card can be used by the ACIO card in a specific period of time. For example, while the user 50 may have three cards for each type of cards, he may choose credit card No. 1 as the credit card to be used for the next five days, debit card No. 3 as the debit card to be used for the next 30 days, promotional card No. 2 as the promotional card to be used in the next day, and discount card No. 2 as the discount card to be used for the next three days. It should be noted that the types of cards mentioned herein are meant to be examplary. There may be other types of cards and some special kinds of cards may not be easily categorized. No matter how many types of cards are possessed by the user 50, the ACIO account 40 may allow the storage of the information and designation of what cards will be used for each category.

When a particular transaction is to take place, the user 50 can initiate some triggering means on the ACIO card 10 to further designate which particular card or cards the ACIO card 10 is to substitute. Such a two-layer selection system ensures that the ACIO card 10 may be used as the entire collection of the user 50's credit cards, debit cards, promotional cards, and discount cards. It also allows the ACIO user 50 to securely control which card is to be used. The details regarding ACIO card 10 is shown in FIGS. 2A and 2B in diagram form.

Shown in FIGS. 2A and 2B are the front and back of an ACIO card 10 having a plastic substrate 110. FIG. 2A demonstrates the front side of the ACIO card 10, including a user name 150, an expiration date 160, a card number 170, an ACIO inscription 180, and four triggering means, herein shown as a credit card selection button 130, a debit card selection button 135, a promotion card selection button 140, and a discount card selection button 145. FIG. 2B demonstrates the back side the ACIO card 10 having a magnetic strip 120.

The ACIO card 10 is similar to a traditional credit card in many ways. For example, the preferred embodiment of the ACIO card 10 is built on a plastic substrate 110 and includes a magnetic strip, both of which have been disclosed in prior arts. However, to integrate the new functions of an ACIO system, an ACIO card 10 has new features that enable a user to utilize the ACIO card 10 as a substitute for all of the user's credit card, debit cards, promotional cards, and discount cards. The ACIO card 10 is a programmable card that the information stored in the magnetic strip can be modified by touch of a button on the ACIO card 10. Such technology to program the magnetic information in a card-like device is known in the art. One such example is the disclosure made in U.S. Pat. No. 6,308,890. However, it should be noted that other methods and technologies may also be used as long as such methods and technologies allow the ACIO card 10 to be programmable.

In the embodiment illustrated in FIGS. 2A and 2B, the ACIO card 10 has four card selection buttons 130, 135, 140, and 145, corresponding to credit cards, debit cards, promotional cards, and discounts, respectively. While the user 50 may assign which four cards are designated to the ACIO card 10, the user 50 may make further designations by pushing any of the buttons 130, 135, 140, 145 before the ACIO card 10 is swiped in a regular card reader. More specifically, the user 50 may press credit card selection button 130, the debit card selection button 135, the promotion card selection button 135, or the discount card selection button 145 to dictate whether the ACIO card 10 will be used as a credit card, debit card, promotional card, or discount card for a particular transaction. Since the previous designation from the ACIO account 40 prepared the ACIO processing server 60 (FIG. 1) which credit card, debit card, promotional card, and discount card the ACIO card 10 is to represent, the ACIO processing server 60 may convert the information relayed to it from the regular card reader to the information of the user 50's specific card. The ACIO processing server 60 may then transfer that information to the issuing bank 70 for approval and then relay the approval or disapproval to the point of sale where the regular card reader 30 is located.

FIG. 1 also demonstrates that the ACIO system 1 may include an ACIO terminal 20. The ACIO terminal 20 is a device that can read ACIO card 10 as well as being accessed by biometric recognition technologies. The ACIO terminal 20 allows a user 50 to access all his/her cards with the ACIO card 10 or without it, if a final verification has been completely.

FIG. 3 shows the basic design of a front panel of an ACIO terminal 20. Shown are a card swiping slot 200, a user picture 210, an ACIO inscription 180, a numeral keypad 220, a fingerprint scanning panel 230, a credit card selection panel 240, a debit card selection panel 245, a promotional card selection panel 250, a discount card selection panel 255, and individual card selection buttons 270. It should be noted that FIG. 3 is only showing the design of the front panel of the ACIO terminal 20 in its most abstract form. Other components may be necessary for the ACIO terminal 20 to provide all its elaborate functions. The elements shown here, combined with the illustrations in FIGS. 1 and 2, shows how the ACIO terminal 20 may be used and how it interacts with other components of the ACIO system.

The ACIO inscription 180 shown in FIGS. 1 and 3 is an indicium to show a name of the business, a trade name, or a trade mark. It may be actually “ACIO.” Or it may be any other name, trade name, or trade mark that is decided to serve as an indication or identifier for the ACIO system.

As indicated by FIG. 1, the ACIO terminal 20 may be accessed using an ACIO card 10. The ACIO card 10 may be swiped through the card swiping slot 200, initiating a process to demonstrate all the information regarding a user 50's entire collection of cards. Additional information or verification, such as an access code, may be inputted through the numeral keypad 220. There additional security measures will prevent someone else from being able to access the information if the user 50 loses his/her ACIO card 10. Furthermore, a user picture 210 will be shown on the ACIO terminal 20, enabling the merchant operating the ACIO terminal 20 to verify that the person accessing the ACIO terminal 20 is indeed the owner of the ACIO card 10. This visual facial identification provides an additional layer of security for the use of the ACIO system.

In addition to using an ACIO card 10 to access an ACIO terminal 20, the user 50 may also complete a transaction simply by ACIO terminal 20 alone, if one is equipped and if user 50's card information is fully integrated in the ACIO system. The user 50 may access the ACIO terminal 20 by biometric recognition technologies, including but not limited to, fingerprint and facial recognition. The embodiment shown in FIG. 3 includes a fingerprint scanning panel 230, via which the user 50 may provide his/her fingerprint. The ACIO terminal 20 may be equipped with programs to analyze the inputted fingerprint and compare it with the information on file. It is important that the user 50 should store the fingerprint information in the ACIO account 40, thus allowing the later access to the ACIO terminal 20 through using the fingerprint scanning panel 230. Similarly, a high resolution digital camera may be used in place of or beside the fingerprint scanning panel 230 to capture the facial image of the user 50. A program for facial recognition and matching may be used to guard the access to the ACIO terminal 20. The programs for fingerprint matching and facial recognition are well known in the art and can be commercially available. Therefore, the ACIO terminal 20 may be implemented with these technologies without much difficulty. Again, if needed, an additional layer of security may be adopted, such as inputting a security code by the user 50, and/or a visual examination of the user and compare it the user picture 210 that may be shown on the ACIO terminal 20.

When the user 50 is fully identified, he/she may access all his/her card information and choose which card is to be used for a particular transaction. The ACIO terminal 20 panel here includes a credit card selection panel 240, a debit card selection panel 245, a promotional card selection panel 250, and a discount card selection panel 255. Under these panels, the individual card selection buttons 270 are listed. As illustrated in FIG. 3 as an example, the user 50 has three credit cards, two debit cards, three promotional cards, and one discount card. The user 50 may choose whatever card he/she wishes to use in a particular transaction. The ACIO terminal 20 panel may be a touch screen monitor that faces the user 50. The user 50 may browse his/her card selections and choose the card he/she wishes to use by pressing the individual card selection buttons 270 on the ACIO terminal 20. It should be noted here that the types of cards shown are meant to be representative. The categorization of the cards and the specific way to show the cards on the ACIO terminal 20 may vary according to the specific needs of the merchant and the specific transactions that need to be completed.

The current invention, therefore, allows the user 50 to complete a financial transaction without a card. Such a design significant simplifies the transactions that may be needed. User 50, in turn, enjoys enormously improved convenience and security. If the ACIO terminal 20 is implemented in a widespread manner, the user 50 does not need any card to make a purchase or retrieve cash. All he/she needs is his/her biometrics, as well as remembering an access code. The entire card collection may be accessed with ease and the user 50 needs not to worry about lost or stolen cards.

As shown in FIG. 1, after the user 50 has made the choice which card or cards will be used for a particular transaction, the ACIO terminal 20, by the operation of the merchant hosting the ACIO terminal 20, sends a request to the ACIO processing server 60; the ACIO processing server 60 relays the request to the issuing banks for approval. The user and the merchant may finish the financial transaction when the approval is sent back. The ACIO terminal 20 allows a wider choice by the user 50 than using the ACIO card 10 on a regular card reader. The designation inputted from the ACIO account 40 does not apply to the ACIO terminal 20 because user 50's entire collection of cards can be accessed.

When a financial transaction is completed, the ACIO system may generate an alert to the user 50. The alert may take the form of an email to a specified email account the user entered, or an automated phone message, either textual or verbal, to a phone number the user asserted. The user 50 may have the authority to allow or disallow the sending of such alerts. In addition, the user 50 may set the threshold, e.g. transactions that involve more than $500, for generating the alerts. Such a design serves as an additional layer of security to ensure that the user is fully aware of his/her financial transactions and reduces the chances of misusing a lost or stolen card.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1: An all-card-in-one (ACIO) system, comprising:
an account into which a user may compile information regarding the user's cards related to financial transactions, wherein
the account categorizes the user's cards into sub-types and allows the user to designates which card will be used for each sub-type;
a processing server able to process card information and relay the card information to an issuing bank.

2: An ACIO system as claim 1, further comprising
a programmable card having a magnetic strip, the card being capable of completing the transactions for a user's collection of cards related to financial transactions, wherein
access to the programmable card allows information to be relayed to the processing server.

3: An ACIO system as claim 2,
the programmable card having triggering means respectively corresponding to the subtypes of cards categorized to by the account, wherein
initiation of the triggering means designates the card to be used as a particular type of card.

4: An ACIO system as claim 2,
the programmable card can be accessed by magnetic readers.

5: An ACIO system as claim 1, further comprising:
a card terminal capable to read a programmable card having a magnetic stripe storing user information,
the card being capable of completing the transactions for a user's collection of cards related to financial transactions, and
the card terminal capable of retrieving all the information regarding the user's cards related to financial transactions.

6: An ACIO system as claim 5, wherein the user can select at the card terminal which card is to be used for a particular transaction.

7: An ACIO system as claim 6, the card terminal further comprising a biometric recognition device.

8: An ACIO system as claim 7, wherein the user can be identified by the biometric recognition device.

9: An ACIO system as claim 8, the biometric recognition device being a fingerprint scanner or a digital camera.

10: An ACIO system as claim 6, the card terminal displaying a picture of the user after the programmable card is read by the card terminal.

11: An ACIO system as claim 8, the card terminal displaying a picture of the user after the user is identified by the biometric recognition device.

12: An ACIO system as claim 5, the card terminal further comprising a numeral keypad, which allows the user to input a security code.

13: An ACIO system as claim 10, the card terminal further comprising a numeral keypad, which allows the user to input a security code.

14: An ACIO system as claim 11, the card terminal further comprising a numeral keypad, which allows the user to input a security code.

15: An all-card-in-one (ACIO) terminal capable to read a programmable card having a magnetic stripe storing user information, the ACIO terminal comprising:
a card information displaying section;
a card reading slot;
a personal picture displaying section; and
a biometric recognition device; wherein
the card reading slot is capable of reading any one of a user's collection of cards related to financial transactions and a programmable card linked to an account storing a user's collection of cards related to financial transactions,
the ACIO terminal is capable of retrieving and displaying all the information regarding the user's cards related to financial transactions,
the user can select at the card terminal which card is to be used for a particular transaction, and
the user can be identified by the biometric recognition device.

16: An ACIO terminal as claim 15, the biometric recognition device being a fingerprint scanner or a digital camera.

17: An ACIO terminal as claim 16, wherein
the ACIO terminal is capable of sending a request to a server for completing a financial transaction.

18: A method allowing a user having multiple cards for financial transaction to use one card as all the user's cards, comprising
the user compiling information regarding the user's cards related to financial transactions into an account;
the account categorizing the user's cards into sub-types and allowing the user to designates which card will be used for each sub-type;
the user using a card that can be designated as any one of the user's cards related to financial transactions;
a card reader sending an inquiry to a processing server; and
the processing server processing card information and relaying the card information to an issuing bank.

19: The method as claim 18, further comprising
an all-card-in-one (ACIO) terminal receiving the information regarding the user's cards related to financial transactions and displaying the information;
the user having an image and the ACIO terminal displaying the user's image, allowing verification of the user,
the user being further verified with biometric identification technology, and
the user selecting on the ACIO terminal which of the cards will be used for a particular transaction.

20: The method as claim 19, further comprising
sending an alert to the user when the user's card related to financial transaction is used to complete a transaction.
